(19) United States
(12) Patent Application Publication
(10) Pub. No.: US 2020/0261989 A1
(43) Pub. Date: Aug. 20, 2020

(54) Drill and method for processing a workpiece

(71) Applicant: Kennametal Inc., Latrobe, PA (US)

(72) Inventor: Herbert Rudolf KAUPER, Rosstal (DE)

(21) Appl. No.: 16/794,679

(22) Filed: Feb. 19, 2020

(30) Foreign Application Priority Data
Feb. 19, 2019 (DE) 102019202165.4

(51) Int. Cl. B23B 51/02; B23B 35/00; B23C 5/10

(52) U.S. Cl. CPC B23B 51/02; B23C 5/10; B23B 35/00

(57) ABSTRACT

A method is provided for processing a workpiece by means of a drill, wherein the drill extends along a longitudinal axis and has a drill tip with a nose angle (S) that is less than 180°, wherein the drill has a lateral surface, on which at least one side blade is formed, which is designed for milling by means of a feeding in a transverse direction (Q) to the longitudinal axis (L), wherein the workpiece has a surface (O), through which a drill hole is drilled, in that in a first step a plane surface is milled into the surface (O) and subsequently in a second step the drill hole is drilled from the plane surface outwards, wherein the plane surface is milled by means of the side blade of the drill in that it is fed forward in a transverse direction (Q) to the longitudinal axis (L), wherein the drill hole is drilled by means of the same drill in that it is fed forward in the direction of the longitudinal axis (L). Further, a corresponding drill is provided.

### RELATED APPLICATION DATA

The present application claims priority pursuant to 35 U.S.C. § 119(a) to German Patent Application Number 102019202165.4 filed Feb. 19, 2019, which is incorporated herein by reference in its entirety.

### FIELD

The invention relates to a drill and a method for processing a workpiece.

### BACKGROUND

A drill, also called a drilling tool, generally serves to machine process a workpiece, and specifically to drill a hole, more precisely a drill hole, into the workpiece. In doing so, the drill is rotated about a longitudinal axis and fed forward in the direction of the longitudinal axis. For drilling the hole, the drill has a drill tip on which a number of main blades are formed in order to remove material from the front and in this manner form the hole. For example, the chips generated in this process are removed from the hole via chip slots on the back side.

When drilling a hole into a workpiece with an inclined surface, the basic problem arises that the drill experiences additional radial forces and is thus diverted laterally. There is the danger that the drill will go off course or slip laterally. An inclined surface is generally not vertical to the longitudinal axis of the drill and is, for example, curved in shape or level with a diagonal course relative to the hole. The hole may then not be set or formed as originally intended. In addition, there are corresponding mechanical loads for the drill.

### SUMMARY

In light of the foregoing, it is a task of the invention to improve the drilling of a hole on an inclined surface. A suitable drill and a suitable method should be specified for this purpose.

The problem is solved according to the invention by means of a method having the features according to claim 1 as well as by means of a drill having the features according to claim 8. Advantageous embodiments, further developments, and variants are addressed in the dependent claims. The statements in connection with the method also apply analogously for the drill and vice versa.

The method serves the processing of a workpiece by means of a drill and machine processing in general. The drill extends along a longitudinal axis. The drill has a drill tip, which is formed on the front of the drill, i.e. pointing frontwards. The drill tip has a nose angle that is less than 180°. The drill tip with the special nose angle serves to drill a hole. The drill has a lateral surface on which at least one side blade is formed. The side blade is designed for milling by way of being fed forward in a transverse direction to the longitudinal axis. The side blade is therefore designed to be high-cutting, in particular in that it is formed with a clearance angle greater than 0°. The transverse direction is thus a milling direction and corresponds to a feed direction of the drill during milling. Here, a feed is generally carried out sideways or laterally, namely in the transverse direction. “Transverse” with respect to a specific direction is generally understood to mean “not vertical,” in particular with respect to this certain direction. Specifically, “transverse” with respect to a specific direction is understood to mean “at an angle of less than 90° and at least at an angle of 60°”, in particular with respect to this certain direction. Overall, the drill is thus first designed as a drill for drilling a drill hole by means of the drill tip and has an additional function of “milling” due to the special side blade, due to which the drill can also be used as a mill and is also expediently used as a mill.

The workpiece has a surface through which a drill hole is drilled, in that in a first step a plane surface is milled on the surface and subsequently in a second step the drill hole is drilled from the plane surface outwards. The surface is, in particular, an inclined surface. In other words: the surface is not level; it is curved or inclined relative to the drill hole, or both. However, the plane surface is a level surface, i.e. the plane surface is level. The plane surface advantageously serves to prepare the drilling on the otherwise inclined surface. The surface is thus initially flattened by means of milling of a plane surface, i.e. smoothed or milled to be level, in order to form the drill hole. The method thus generally comprises two steps, namely a preparatory step as the first step, which precedes a drilling as the second step and prepares the drilling.

The plane surface is milled by means of the side blade of the drill in that it is fed forward in a transverse direction to the longitudinal axis. In the first step, the milling function of the drill is thus used in order to prepare the surface of the workpiece for the subsequent drilling. For this purpose, the drill is not exclusively fed forward in an axial direction, but rather predominantly or exclusively laterally or sideways, i.e. transverse to the longitudinal axis. In a suitable embodiment, the drill is fed exactly vertically to the longitudinal axis and thus in a radial direction. By contrast, in another suitable embodiment, the drill is not fed exactly in a radial direction, but rather generally transversely to the longitudinal axis.

Subsequent to the milling of the plane surface, the drill hole is drilled by means of the same drill, in that said drill is fed forward in the direction of the longitudinal axis. In particular, the drill is fed exclusively in the direction of the longitudinal axis, i.e. in the axial direction, whereas a lateral feeding is not performed. Thus, in the second step, the drill removes material from the workpiece exclusively on the front side, in particular, by means of the drill tip. During drilling, the drill is preferably arranged in such a way that the longitudinal axis is vertical to the plane surface, so that lateral forces on the drill are avoided. In particular, the finished drill hole then extends vertically with respect to the previously formed plane surface and generally inclined with respect to the surface previously provided in the area of the plane surface. Thereafter, the drill hole has an inclined entry angle, i.e. an entry angle that is inclined with respect to the original surface. In an equivalent view from the other side, the surface is inclined with respect to the drill hole. Preferably, the drill hole is formed by means of the drill with a hole depth corresponding at least to a diameter of the drill. The drill hole is therefore not merely a recess in the surface, but rather extends into the workpiece and thereby also has a particularly cylindrical inner wall or drill hole wall.

For drilling, the drill tip has in particular multiple main blades and the nose angle indicates at what angle the main blades are positioned with respect to one another. Overall, the drill tip is formed conically, where the main blades lie on an imaginary conical lateral surface. The nose angle then corresponds to a conical nose angle formed by the conical lateral surface. By contrast to a mill, in a drill the nose angle is generally positive, i.e. less than 180°, so that the drill tip points outwards. By contrast, in a mill the nose angle is at least 180° and typically more than 180°, resulting in a tip geometry that is sunken in at the front of a mill. This is also called a negative nose angle. The nose angle is an essential criterion for differentiating a mill from a drill. Due to the negative nose angle, a mill is typically not suitable for drilling, because a machine processing of the workpiece is not possible on the front.

A core concept of the invention is, in particular, to simplify the drilling on any surface, and thus advantageously also on an inclined surface, in that the milling in preparation of the drilling as well as the drilling itself are performed by means of the same tool. A special drill is used as the tool, which is a drill in and of itself, having an additional milling function. The drill is therefore a multifunction tool. The milling of the plane surface and the subsequent drilling of the drill hole from the plane surface outwards are then advantageously performed with the same tool, so that a complex tool change is not required and, preferably, such a tool change can be omitted. This significantly reduces processing time. For drilling a drill hole into a workpiece with a surface that is inclined relative to the planned drill hole, it is therefore not necessary to previously mill explicitly the surface to be level by means of a mill; rather, this occurs directly with the drill in the first step.

An important aspect of the drill is, in particular, the specially designed side blade. In a drill, the side blade generally extends along the lateral surface of the drill. The side blade begins on the front side on the drill tip and, in particular, represents a continuation of a main blade along the lateral surface, so to speak. A main blade of the drill extends from a center of the drill, typically from a cross-blade in the center, outwards to the lateral surface. There, the main blade ends in a cutting corner, which in particular also forms a radially outermost point of the drill. From the cutting corner outwards, the side blade then extends from front to back with respect to the drill.

The side blade follows a chip slot, in particular, which adjoins the main blade in the rotational direction of the drill. The chip slot serves to remove chips that are raised up by the main blade during operation of the workpiece. The chip slot is suitably designed to be coiled and extends about the longitudinal axis in the shape of a screw-line or helix. The side blade delimits the chip slot and thus follows its course, i.e. it also runs in a coiled manner about the longitudinal axis.

In principle, the side blade is expediently designed in such a way that the drill is stabilized laterally in the drill hole during drilling. For this purpose, a guide chamfer is advantageously formed on the side blade, protruding in a radial direction, i.e. the remaining lateral surface set back with respect to the guide chamfer. The guide chamfer then slides along the inner wall of the drill hole and stabilizes the drill; however, because the remaining lateral surface is set back, it is not in contact with the inner wall, so that a friction of the drill in the drill hole is advantageously reduced.

The side blade is typically designed without a clearance angle, so that the lateral surface or at least one guide chamfer adjoins the inner wall of the drill hole. Now, in order to realize the milling function, the side blade for milling is formed by means of a feeding in the transverse direction to the longitudinal axis, i.e. in particular in that the side blade is designed to be high-cutting, having a clearance angle of greater than 0° for this purpose. Through a sideways movement, i.e. a feeding in the lateral direction, the side blade can then engage with the workpiece and lift the material. The drill is thus designed for machine processing through feeding in the transverse direction. For this purpose, the side blade is ground in a suitable manner during manufacture of the drill, so that a cutting effect is achieved when operated as intended. In the present drill, a guide chamfer on the side blade is expediently omitted.

In a preferred embodiment, the side blade is designed for milling with a clearance angle of at least 5° and no more than 30°. This range of values for the clearance angle is particularly suitable for milling of the plane surface in the first step and, however, simultaneously guarantees a good stabilization of the drill during drilling in the second step.

Preferably, the nose angle is no more than 170°. The drill is thus formed flatly overall, i.e. flat in comparison to a typical nose angle of 140° for drills. Through this flat embodiment, the milling function of the drill is supported, in particular because the drill must then only be slightly inclined for milling, at the most.

The special drill differs from a mill, in particular, not merely due to the special nose angle and multiple main blades, as mentioned above, but also preferably due to a core diameter that is smaller compared to a mill. In a drill and a mill, and generally in a rotary tool, the core diameter provides the diameter of the core of the tool. Here, the core is defined by a penetration depth of the chip slots and refers specifically to the area of the tool up to which the chip slots penetrate. In the case of a mill, the core diameter is typically large and corresponds to more than half of the diameter of the mill, in order to guarantee the greatest possible stability during a sideways movement of the mill. By contrast, in a drill the core diameter is smaller and is, in particular, no more than half the diameter of the drill, preferably no more than a quarter of the diameter, so that an especially large amount of space is provided for the chip removal.

For milling, the drill is fed laterally, namely in the lateral direction. In a preferred embodiment, during milling in the first step, the drill is fed with an inclined longitudinal axis, in that the drill is positioned such that the transverse direction forms an angle with the longitudinal axis which corresponds to half of the nose angle. The drill is therefore inclined with respect to the transverse direction, i.e. with respect to a direction of movement during milling. The incline is dependent upon the nose angle and is selected such that when turning the drill, the imaginary conical lateral surface is ground over the plane surface on one side, so to speak. The drill tip is therefore not used for the front-facing processing, but rather material is removed exclusively by means of the side blade. The main blades of the drill are therefore not used during milling. Therefore, during the milling, the drill tip does not dip into the workpiece, so that a consistently level plane surface is advantageously produced. Depending upon the embodiment of the drill tip, a slot or groove may be formed in the level plane surface in the transverse direction, which is produced by a cross-blade, which protrudes in the axial direction with respect to the main blades. When viewed in a cross-section along the longitudinal axis, however, the drill tip is generally located on the plane surface on one side due to the conical design, while the other side is at an angle to the plane surface corresponding to the difference between a half angle of 180° and the nose angle. In an exemplary drill with a nose angle of 178°, the conical drill tip thus lies on the plane surface on one side, and the other side runs at an angle of 2° to the plane surface.

In an advantageous embodiment, a side wall is formed by the side blade in the first step. This side wall adjoins the plane surface, particularly in the transverse direction. The side wall is formed, in principle, parallel to the lateral surface, because the side blade is of course arranged in the lateral surface. Further, the side wall extends from the plane surface outwards at an angle that is also called a lateral angle. In general, the lateral angle corresponds to the angle that is formed between the lateral surface and a respective main blade, i.e. the imaginary conical lateral surface of the drill tip. The lateral angle therefore corresponds to an angle of the drill at the cutting corner, so that the lateral surface forms the outer contour of the drill in combination with the plane surface. Particularly preferred is an embodiment in which the side wall forms an angle with the plane surface, i.e. the lateral angle, which corresponds to the difference between a half angle, i.e. 180°, and half of the nose angle. For this purpose, the lateral surface runs parallel to the longitudinal axis, at least on the front side of the drill. In an exemplary drill with a nose angle of 178°, the main blade and the lateral surface then form an angle of 91° and, accordingly, the lateral angle between the plane surface and the side wall is thus also 91°.

In particular, the side wall results from the fact that the surface of the workpiece is inclined and, during milling of the plane surface, is locally milled to be level, so that a corresponding stage is formed, which then delimits the plane surface from the remaining surface, which is unprocessed. The side wall then defines the height of the stage. Depending upon the incline of the surface and thus of the side wall, the height of the stage is, for example, 0.01 mm and up to 8 times the diameter.

The side wall is preferably designed as a chamfer for the drill hole and, during drilling, and particularly preferably during a subsequent deep hole drilling, serves as a guide. In a suitable embodiment, the side wall is used as a guide for the drill itself. Particularly preferably, however, the side wall is used alternatively or additionally as a guide for another drill, which is used to drill the drill hole, in particular to further process the drill hole. The use of the side wall as a guide is particularly suitable for deep hole drilling if the drill is used as a pilot drill. By means of the same drill, the plane surface is first produced, followed by the drill hole as a pilot drilling for a subsequent deep hole drill, i.e. after the drilling of the drill hole, the drill is exchanged for a deep hole drill, by means of which a deep drill hole is drilled into the workpiece from the drill hole outwards. The side wall, which is slightly inclined with respect to the longitudinal axis of the deep hole drill, as well, advantageously serves to simplify the insertion of the deep hole drill into the pilot drilling.

Advantageously, after milling of the plane surface in the first step and before drilling the drill hole in the second step, the drill is inclined such that the longitudinal axis of the drill is vertical with respect to the plane surface. After the plane surface has been milled, the drill is then inserted into it, so to speak, in that the drill is inclined such that the drill tip is pushed into the plane surface. The longitudinal axis is thus brought into a vertical alignment with the plane surface, so that during the subsequent drilling of the drill hole, the drill is fed forward from a surface that has been optimally milled level and is generally smooth. As a result, lateral forces that would otherwise occur with an inclined surface are advantageously avoided. The general conical drill tip is therefore set upright with respect to the plane surface and, in particular, is brought from a partially resting alignment into an alignment that is pointed to or into the plane surface. The angle by which the longitudinal axis is inclined is dependent upon the nose angle and corresponds to half of the difference between a half angle of 180° and the nose angle. In an exemplary drill with a nose angle of 178°, the longitudinal axis between the first and second step is thus inclined by 1°.

In an expedient embodiment, after milling of the plane surface, the drill is fed back against the transverse direction, so that when drilling the drill hole, a landing is formed by the plane surface. In particular, the drill is fed back against the transverse direction, i.e. in cross-transverse direction. In the case of the formation of a side wall, the back-feeding intentionally forms a distance between the side wall and the drill, more precisely its lateral surface, so that the drill is brought into a particularly relaxed axial position for the subsequent drilling, in which correspondingly low lateral forces are at work. In addition, a friction of the drill on the side wall is advantageously avoided. Preferably, the drill is fed back by at least 0.05 mm and no more than 1 mm. The distance to a side wall that may be formed is then at least 0.05 mm and no more than 1 mm.

By feeding the drill back, a corresponding landing is also formed, which is referred to as an overhang, an edge, or a partially formed collar with respect to the subsequently drilled drill hole, in particular a deep drill hole. The drill hole therefore does not directly transition into the side wall and is also not flush with it, but rather is designed to be set back with respect to the remaining surface surrounding the plane surface. Thus, the drill hole is not directly adjacent to the remaining, unprocessed surface at least in the transverse direction, but is rather distanced from it by a part of the plane surface, namely the landing.

The drill and the method can be used advantageously in various contexts. In any case, through the integration of a milling function in a drill the advantage is that a tool change is not necessary for drilling a hole on a generally inclined surface, for example a curved, uneven, or oblique surface.

In an expedient embodiment, the drill hole is designed as a pilot drill hole, and this pilot hole is subsequently further formed as a deep drill hole by means of a separate deep hole drill. Accordingly, the drill is designed as a pilot drill, with which the drill hole is formed as a pilot drill hole within the framework of a pilot drilling, which is subsequently further formed into a deep drill hole by means of a separate deep hole drill. For deep hole drilling, a tool change thus occurs, in which the pilot drill is replaced by a deep hole drill in order to continue forming the drill hole.

A deep hole drill is characterized in particular in that it has a length that is at least 10 times a diameter of the deep hole drill. When determining the length, a shaft of the drill for clamping into a tool machine is not considered, in particular. The deep hole drill is therefore significantly longer than it is wide, whereby a corresponding deep drill hole is produced, which is correspondingly deeper than it is wide.

Here, the drill is preferably designed as a pilot drill in order to create a pilot drilling. A pilot drilling is characterized in particular in that while it is indeed a drilling, a further processing of the drilling occurs in a subsequent step, preferably the creation of a recess. This is particularly advantageous in deep hole drilling, as already described above. Using the pilot drill, the surface of the workpiece is first milled to be level, and then a pilot drill hole is created by means of the same drill, without a tool exchange. Then, the pilot drill is replaced by a different tool, in particular a deep hole drill. For this other tool, the hole then serves as a positioning aid. A pilot drill is characterized against a deep hole drill, in particular, by a smaller length, which in a suitable embodiment is at least 1 time and no more than 5 times the diameter of the drill.

In order to reduce the friction in the drill hole during drilling, the drill is preferably tapered towards the rear, thus having a diameter which is reduced starting from the drill tip and running backwards in the longitudinal axis. Along the drill, the diameter is then preferably reduced by 0.1 mm to 0.5 mm per 100 mm length of the drill, i.e. the diameter decreases by 0.1 mm to 0.5 mm over a length of 100 mm.

For milling, the side blade is designed to be high-cutting, as described above. In a first suitable embodiment, the entire side blade is designed for milling. In other words: the side blade has a clearance angle greater than 0° along its entire length. This makes the manufacture of the drill particularly easy.

Alternatively to an embodiment in which the entire side blade is designed for milling, an equally suitable embodiment provides the side blade merely on a front-facing milling section for milling. The milling section is also called the front section. The side blade is therefore not designed to be high-cutting overall, but only on the front side and in the area of the drill tip. In particular, this is based upon the consideration that it is sufficient for a typical surface to provide a milling function only on the front, because a further penetration of the drill is not necessary in the first step. Ideally, the milling section has a length of at least 1 mm and no more than 10 mm.

In a suitable further training, the side blade is two-staged, in that a rear drilling section adjoins the front-facing milling section, wherein the milling section has a milling diameter that is smaller than a drilling diameter of the drilling section. Accordingly, a drilling section adjoins the milling section at the rear, which is also called the rear section. In particular, the drilling section primarily serves the formation of the drill hole in the second step of the method. The milling section and the drilling section are thus arranged behind one another along the longitudinal axis, wherein the milling section is formed on the front of the drill and the drilling section behind it. The side blade is designed to be high-cutting on the milling section, but not on the drilling section, i.e. the side blade has a clearance angle of 0° on the drilling section, in particular, such that the drilling section is designed in the style of a drill overall. The drilling section has a diameter that is vertical to the longitudinal axis, which is also called a drilling diameter. Accordingly, the milling section has a diameter that is vertical to the longitudinal axis, which is also called a milling diameter. The milling diameter is less than the drilling diameter. The milling section is therefore offset in a radial direction with respect to the drilling section, in particular it is set back inwardly with respect to the longitudinal axis, so that a stage is formed in particular at the transition between the milling section and the drilling section. In one embodiment, this results in particular due to the fact that during the manufacture of the drill, the side blade on the milling section is ground in its manufacture, and thus material is removed relative to the drilling section. On the other hand, the differing diameters guarantee that the milling section is optimally designed for milling and, during drilling, no unwanted material removal occurs on the inner wall of the drill hole and, during drilling, the drill is optimally guided in the drill hole by the drilling diameter.

A particular advantage of the embodiment with the two-stage side blade is that both the drill tip for drilling as well as the milling section for milling can each be reground without affecting the drilling diameter for the drilling as a result of the regrinding. Regrinding is preferably performed only on the milling section. The drilling diameter is advantageously retained, so that a continuously high precision is guaranteed for a subsequent process, specifically a subsequent deep hole drilling or other drilling.

Due to the different diameters along the longitudinal axis, there is a stage at the transition from the milling section to the drilling section, where the side blade accordingly transitions from a high-cutting part to a non-high-cutting part. On this stage, there is an edge in the radial direction, which bridges the difference between the two diameters and connects both parts of the side blade to one another. This edge is expediently designed as a blade, in order to continue removing material while in operation and to expand the drill hole diameter from the milling diameter to the drilling diameter.

When processing a workpiece with a two-stage side blade, i.e. an overall two-stage drill, the plane surface is first milled, as already described. When dimensioning the plane surface, it is expediently considered that the drilling diameter is greater than the milling diameter. For this purpose, the plane surface is milled in such a way that it is at least as large as the drilling diameter. For this purpose, during milling of the plane surface, the drill is guided along a milling path, which, in a suitable embodiment, has two longitudinal sections that offset from one another, so that a plane surface which is greater than the milling diameter is milled. Then, the drill is positioned in particular centrally over the plane surface and inserted for drilling. In principle, the milling section first penetrates the workpiece, however followed by the drilling section with a further feeding in the longitudinal direction, which expands the drill hole to the drill hole diameter.

In deep hole drilling, the deep hole drill used after the two-stage drill preferably has a deep hole drilling diameter corresponding to the drilling diameter but with a lower tolerance. Through this coordination of the diameter, a particularly good guide of the deep hole drill and a particularly high precision during deep hole drilling is guaranteed.

### BRIEF DESCRIPTION OF THE DRAWINGS

In the following, exemplary embodiments of the invention are explained in greater detail by means of a drawing. The following are shown, each schematically:

FIG. 1 A drill and a workpiece with an inclined surface,

FIG. 2 a first step in the processing of the workpiece from FIG. 1,

FIG. 3 a second step in the processing of the workpiece from FIG. 1,

FIG. 4 the formation of a deep drill hole in the workpiece from FIG. 1,

FIG. 5 an enlarged view of the first step from FIG. 2,

FIG. 6 an enlarged view of the transition from the first step from FIG. 2 to the second step of FIG. 3,

FIG. 7 an enlarged view of the second step from FIG. 3,

FIG. 8 the drill from FIG. 1 in a front view,

FIG. 9 a detailed view of a section of the drill from FIG. 1,

FIG. 10 the drill from FIG. 1 in a cross-sectional view,

FIG. 11 the drill from FIG. 1 in a side view

FIG. 12 a variant of the drill and a workpiece in a side view,

FIG. 13 the arrangement from FIG. 12 in a top view,

FIG. 14 the arrangement from FIG. 12 in a first step,

FIG. 15 the arrangement from FIG. 14 in a top view,

FIG. 16 the arrangement from FIG. 12 in a second step,

FIG. 17 the arrangement from FIG. 16 in a top view,

FIG. 18 the workpiece from FIGS. 12 to 17 and a deep hole drill.

### DETAILED DESCRIPTION

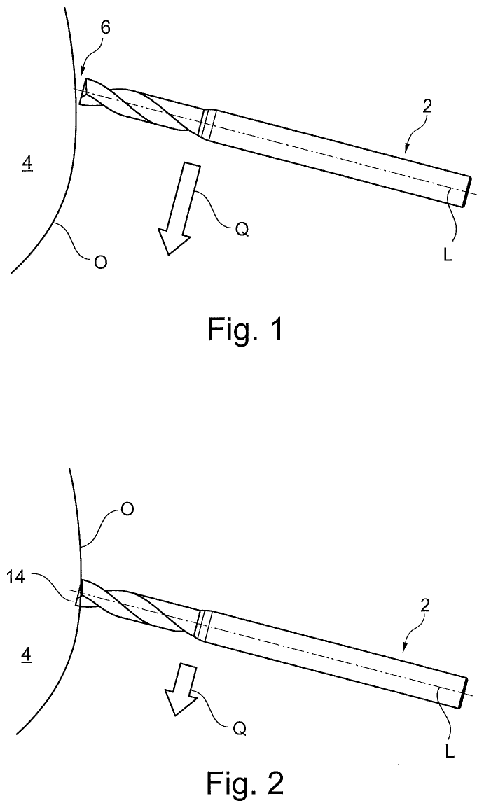

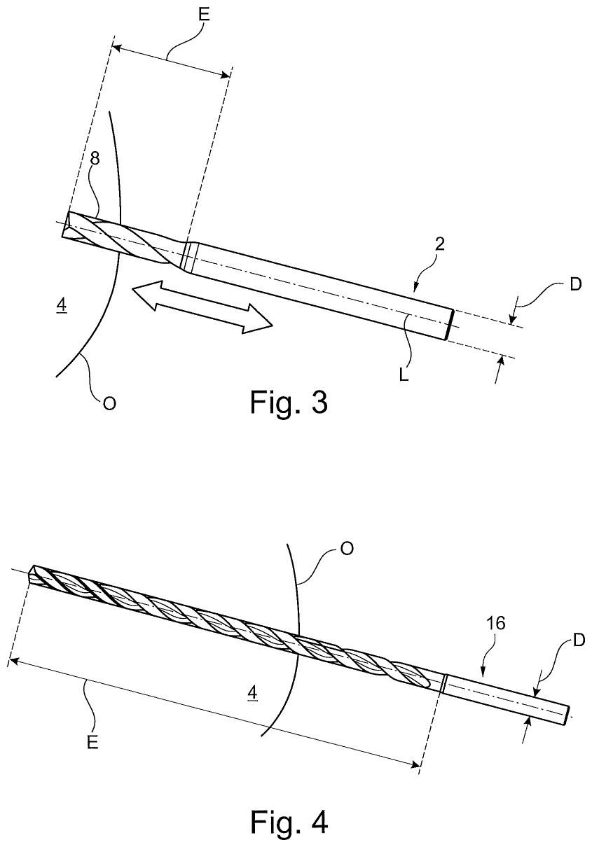

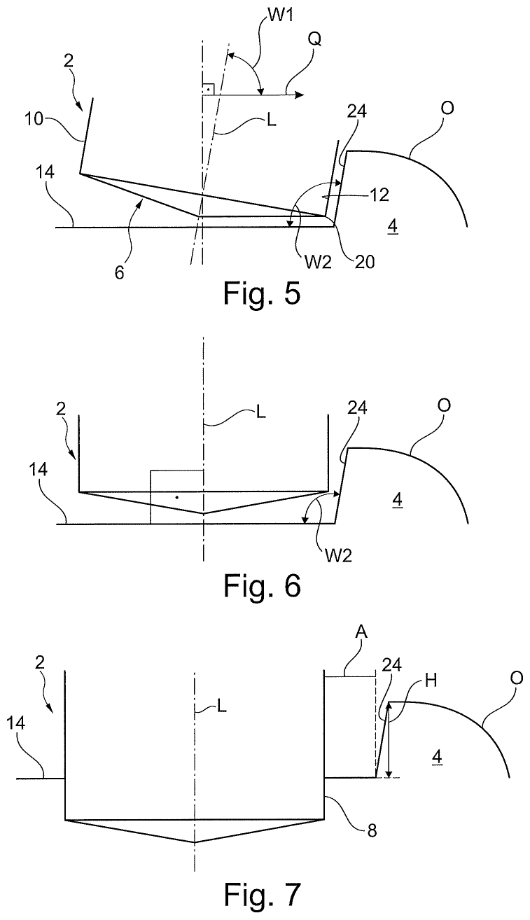

FIGS. 1 to 7 show sections of a method in which a workpiece 4 is processed by means of a drill 2. FIGS. 5 to 7 show excerpts of the process from FIGS. 2 and 3 in an enlarged view. The drill 2 is shown in more detail in FIGS. 8 to 11 in various views. The drill 2 extends along a longitudinal axis L and has a drill tip 6, which is designed to be front-facing on the drill 2, i.e. pointed frontwards. As is discernible in FIGS. 5 to 7, in particular, but also in FIG. 11, the drill tip 6 has a nose angle S that is less than 180° and, here, no more than 170°, so that the drill 2 is formed flat overall. The drill tip 6 with the special nose angle S serves for drilling a drill hole 8. The drill 2 has a lateral surface 10, on which at least one side blade 12 is formed, which is clearly discernible in the enlarged section of FIG. 9, in particular. The side blade 12 is designed for milling by means of a feeding in a transverse direction Q to the longitudinal axis L, whereby the transverse direction Q does not necessarily run vertically to the longitudinal axis L. Here, the side blade 12 is designed to be high-cutting, in that it is formed with a clearance angle F greater than 0°. The transverse direction Q is a milling direction and corresponds to a feeding direction of the drill during milling.

In FIGS. 1 to 7, the workpiece 4 has a surface O, through which a drill hole 8 is drilled. For this purpose, as shown in FIGS. 1 and 2, a plane surface 14 on the surface O is milled in a first step. In FIG. 1, the drill 2 is first guided to the workpiece 4 and then inserted into it laterally in FIG. 2. Then, as shown in FIG. 3, in a second step the drill hole 8 is drilled from the plane surface 14 outwards. The surface O is an inclined surface O and, here, completely curved and, in any case, not level. By contrast, the plane surface 14 is a level surface and serves to prepare the drilling on the otherwise inclined surface O. The surface O is thus first milled to be level by means of milling of the plane surface 14, as shown in FIG. 2, in order to then form the drill hole 8, as shown in FIG. 3. The method thus generally comprises two steps, namely a preparatory step as shown in FIG. 2 as a first step and a drilling as shown in FIG. 3 as a second step. A special drill 2 is used here, which is a drill in and of itself having an additional milling function. The drill 2 is therefore a multifunction tool here. In the first step, the milling function of the drill 2 is used to prepare the surface O of the workpiece 4 for the subsequent drilling. Here, the drill 2 is moved sideways, as shown by arrows in FIGS. 1 and 2. Then, a drilling function is used in order to drill the drill hole 8, as shown in FIG. 3. A tool exchange is omitted here.

In the exemplary embodiment shown, the drill hole 8 is used as shown in FIG. 4 in order to drill a deep hole by means of a deep hole drill 16. In the exemplary embodiment shown, the original drill hole 8 thus serves as a pilot drill hole for a deep hole drilling. The drill 2 is accordingly a pilot drill and, after drilling of the drill hole 2, there is a tool exchange. Alternatively to a deep drill hole as shown in FIG. 4, in a variant not shown, only a drill hole 8 is drilled as seen in FIGS. 1 to 3, wherein the step in FIG. 4 is omitted and thus no deep drill hole is drilled.

The drill 2 generally has a length E and a diameter D. To reduce friction in the drill hole during drilling, in a variant not shown, the drill 2 is tapered to the rear, thus having a diameter D which is reduced starting from the drill tip 6 and running backwards in the longitudinal axis L.

In FIG. 3, the drill hole 8 is drilled by means of the same drill 2 with which milling is performed in FIG. 2 in that this drill 2 is fed forward towards the longitudinal axis L. In doing so, the drill 2 removes material from the workpiece 4 on the front side by means of the drill tip 6. During drilling, the drill 2 is further arranged in such a way that the longitudinal axis L is vertical to the plane surface 14, so that lateral forces on the drill 2 are avoided. The finished drill hole 8 then extends vertically with respect to the previously formed plane surface 14.

For drilling, as seen in FIG. 8, the drill tip 6 has multiple main blades 18, and the nose angle S indicates at what angle the main blades 18 are positioned with respect to one another. Overall, the drill tip 6 is formed conically, where the main blades 18 lie on an imaginary conical lateral surface. The nose angle S then corresponds to a conical nose angle formed by the conical lateral surface. The nose angle S is positive, i.e. less than 180°, so that the drill tip 6 points outwards.

A main blade 18 of the drill 2 extends from a center Z of the drill 2 outwards to the lateral surface 10. There, the main blade 18 ends in a cutting corner 20. The special side blade 12 of the drill 2 starts on the front side of the drill tip 6 and forms a continuation of the main blades 18 along the lateral surface 10. Starting from the cutting corner 20, the side blade 12 extends from front to rear with respect to the drill 2. As is discernible for example in FIG. 11, the side blade 12 follows a chip slot 22, which adjoins the main blade 18 in the rotational direction of the drill 2 and serves to remove chips.

Now, in order to realize the milling function, the side blade 12 for milling is formed by means of a feeding in the transverse direction Q, having a clearance angle F of greater than 0° for this purpose. For this purpose, the side blade 12 is ground during manufacture of the drill 2, as can be seen especially well in the enlarged view of FIG. 9, so that a cutting effect is achieved when operated as intended. The clearance F of the side blade 12 is between 5° and 30° here. A guide chamfer on the side blade 12 was omitted in the present drill 2. In an embodiment not shown, the side blade 12 has a clearance angle F of greater than 0° along its entire length. As a result, the manufacture of the drill 2 is particularly simple. In the variant shown, by contrast, the side blade 12 is formed only on a front-facing milling section 26 for milling, i.e. only on the front side and in the area of the drill tip 6.

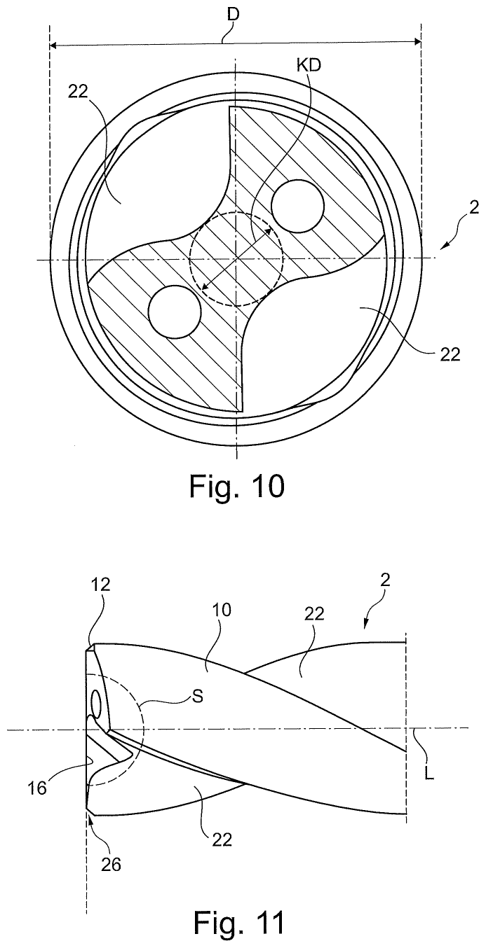

The drill 2 shown differs from a mill not merely due to the special nose angle S and multiple main blades 18, but also due to a core diameter KD that is smaller compared to a mill. Here, the core diameter KD of the drill 2 is at most half of the diameter D of the drill 2. This is particularly clearly discernible in FIG. 10, which shows the drill 2 in a sectional view vertical to the longitudinal axis L.

In the embodiment shown, in the first step during milling, the drill 2 is fed with an inclined longitudinal axis L, as shown in FIG. 1 and discernible in FIG. 5 in detail. For this purpose, the drill 2 is positioned in such a way that the transverse direction Q forms an angle W1 with the longitudinal axis L corresponding to half the nose angle S. The drill 2 is therefore inclined with respect to the transverse direction Q. The incline is dependent upon the nose angle S and is selected such that when turning the drill 2, the imaginary conical lateral surface is ground over the plane surface 14. The drill tip 6 is therefore not used for the front-facing processing, but rather material is removed exclusively by means of the side blade 12. By contrast, the main blades 18 are not used during milling.

In the first step, a side wall 24 is formed by means of the side blade 12, said side wall adjoining the plane surface 14 when viewed in the transverse direction Q. This is shown in detail in FIG. 5, where the drill 2 is shown at somewhat of a distance from the workpiece 4 merely for better visibility. The side wall 24 is formed, in principle, parallel to the lateral surface 10 and extends from the plane surface 14 outwards at an angle that is also called a lateral angle W2. The lateral angle W2 generally corresponds to an angle of the drill 2 at the cutting corner 20, so that the lateral surface 24 forms the outer contour of the drill 2 in combination with the plane surface 14. In the drill 2 with a nose angle S of 178° shown, the main blade 18 and the lateral surface 10 form an angle of 92°, and accordingly, the lateral angle W2 between the plane surface 14 and the side wall 24 is also 92°. Due to the side wall 24, a stage is formed, which then delimits the plane surface 14 from the remaining surface O. The side wall 24 then defines a height H of the stage, which typically lies between 0.01 mm and 8 times the drilling diameter Db.

In the second step, the side wall 24 then forms a chamfer for the drill hole 8 and thus serves as a guide during drilling. This use of the side wall 24 as a guide is particularly suitable for deep hole drilling, as shown in FIG. 4, and when the drill 2 is used as a pilot drill. By means of the same drill 2, the plane surface 14 is first created, and then the drill hole 8 is used as a pilot drilling for the subsequent deep hole drill 16.

In addition, in the exemplary embodiment shown after milling the plane surface 14 in the first step and before drilling the drill hole 8 in the second step, the drill 2 is inclined such that the longitudinal axis L of the drill 2 is vertical to the plane surface 14. This is shown in more detail in FIG. 6. The longitudinal axis L is thus brought into vertical alignment with the plane surface 14, so that during the subsequent drilling of the drill hole 8, the drill 2 is fed outwards from a surface O that is optimally milled to be level or generally smooth. The angle about which the longitudinal axis L is inclined is dependent upon the nose angle S and corresponds to half of the difference between a half angle of 180° and the nose angle S. In the exemplary drill 2 with a nose angle of 178° shown here, the longitudinal axis L is inclined by 1° between the first and the second step.

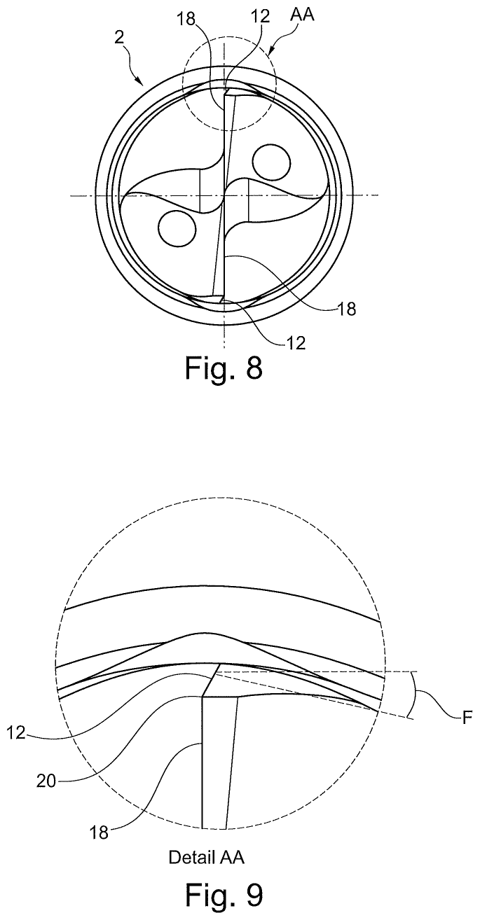

After milling of the plane surface 14, the drill 2 is fed back against the original transverse direction Q, so that when drilling the drill hole 8, a landing 28 is formed by the plane surface 14, as shown in FIG. 7. A distance A between the side wall 24 and the drill 2 is formed as a result of this back-feeding. The drill 2 is fed back by at least 0.05 mm and no more than 1 mm, so that the distance A to the side wall 24 is accordingly between 0.05 mm and 1 mm.

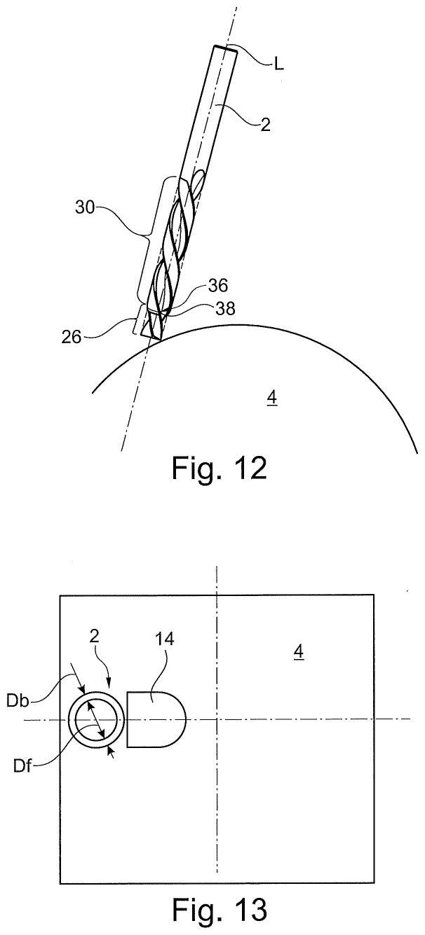

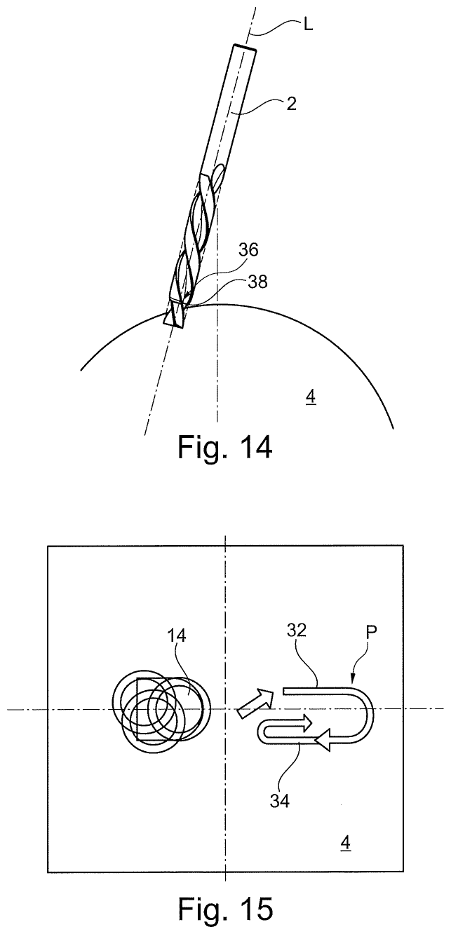

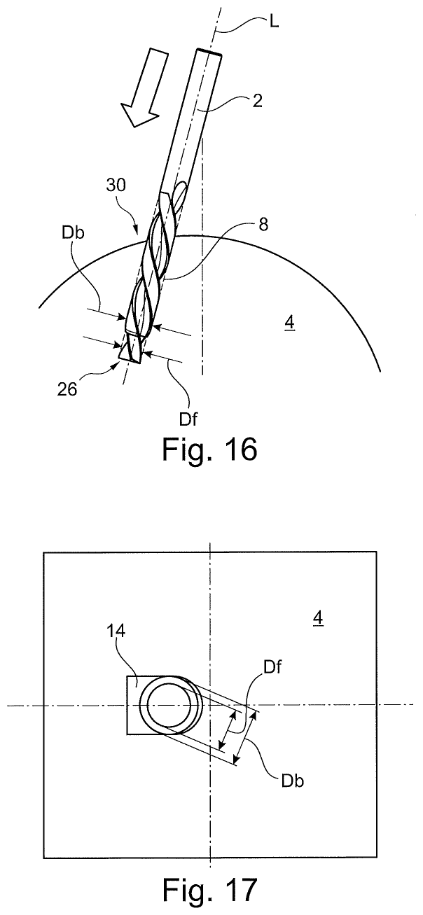

A variant of the drill 2 is shown in FIGS. 12 to 17. FIGS. 12 to 15 show the milling of the plane surface 14 in a first step, and FIGS. 16 and 17 show the drilling of the drill hole 8 in a second step. FIGS. 12, 14, and 16 each show the drill 2 and the workpiece 4 in a lateral view, and FIGS. 13, 15, and 17 show a top view of the workpiece 4 corresponding to the respective lateral view. The drill 2 is designed to be two-staged, i.e. the side blade 12 is two-staged, in that a rear drilling section 30 adjoins the front-facing milling section 26. The milling section 26 has a milling diameter Df, which is less than a drilling diameter Db of the drilling section 30. The milling section 26 and the drilling section 30 are thus arranged behind one another on the longitudinal axis L, wherein the milling section 26 is formed on the front of the drill 2 and the drilling section 30 is behind it. The side blade 12 is designed to be high-cutting on the milling section 26, as already described, but not on the drilling section 30, being formed there in the style of a drill. In FIGS. 13, 15, and 17, the drill is shown in a simplified view as a ring, in order to illustrate the milling diameter Df and the comparatively larger drilling diameter Db.

When processing the workpiece 4, the plane surface 14 is first milled, as already described. For this purpose, the drill is fed laterally, as shown in the FIGS. 12 and 13, and guided to the workpiece 4. In FIG. 13, the later plane surface 14 is already marked for better clarity, however, it is actually not yet incorporated into the workpiece 4. However, it is made clear that in the dimensioning of the plane surface 14, the larger drilling diameter Db is already taken into account, and the plane surface 14 should be milled in such a way that it is at least as large as the drilling diameter of Bd [sic: Db]. For this purpose, FIG. 15 shows a milling path P, along which the drill 2 is guided during milling of the plane surface 14. For better clarity, the milling path P is drawn in the offset position in FIG. 15. In addition, three positions of the drill 2 along the milling path P are identified by corresponding rings in FIG. 15. The milling path P comprises two longitudinal sections 32, 34 that are offset to one another, so that a plane surface 14 greater than the milling diameter Df is milled. As the milling path P further shows in FIG. 15, the drill 2 is then positioned centrally over the plane surface 14 and, as shown in FIGS. 16 and 17, inserted for drilling into the workpiece 4, in that the drill 2 is fed forward in the direction of the longitudinal axis L. In principle, the milling section 26 initially penetrates the workpiece 4, followed by the drilling section 30, which expands to the drill hole 8 to the drilling diameter Db.

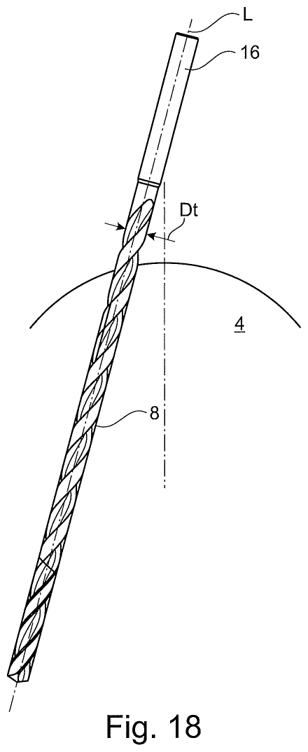

Due to the different diameters Df, Db along the longitudinal axis L, there is a stage 36 at the transition from the milling section 26 to the drilling section 30, where the side blade 12 accordingly transitions from a high-cutting part to a non-high-cutting part. At this stage 36, there is an edge 38 in the radial direction, which bridges the difference between the two diameters Df, Db and connects the two parts of the side blade 12 to one another. Here, this edge 38 is designed as a blade, in order to continue removing material while in operation and to expand the drill hole diameter from the milling diameter Df to the drilling diameter Db. In a subsequent deep hole drilling, and in the deep hole drilling shown in FIG. 18 for example, the deep hole drill 16 used after the two-stage drill 2 preferably has a deep hole drilling diameter Dt corresponding to the drilling diameter Db but with a lower tolerance.

1. A method comprising processing a workpiece by means of a drill,
wherein the drill extends along a longitudinal axis and has a drill tip with a nose angle that is less than 180°,
wherein the drill has a lateral surface, on which at least one side blade is formed, which is designed for milling by means of a feeding in a transverse direction to the longitudinal axis,
wherein the workpiece has a surface, through which a drill hole is drilled, in that in a first step a plane surface is milled into the surface and subsequently in a second step the drill hole is drilled from the plane surface outwards,
wherein the plane surface is milled by means of the side blade of the drill in that it is fed forward in a transverse direction to the longitudinal axis,
wherein the drill hole is drilled by means of the same drill in that it is fed forward in the direction of the longitudinal axis.

2. The method according to claim 1,
wherein, during milling, in a first step the drill is fed forward with an inclined longitudinal axis, in that the drill is positioned in such a way that the lateral direction forms an angle with the longitudinal axis that corresponds to half of the nose angle.

3. The method according to claim 1,
wherein in a first step a lateral wall is formed by the side blade, which adjoins the plane surface and extends from the plane surface at an angle that corresponds to the difference between 180° and half of the nose angle.

4. The method according to claim 3,
wherein the lateral wall is designed as a chamfer for the drill hole and serves as a guide during drilling.

5. The method according to claim 1,
wherein, after milling of the plane surface in the first step and before drilling of the drill hole in the second step, the drill is inclined such that the longitudinal axis of the drill is vertical to the plane surface.

6. The method according to claim 1,
wherein, after milling of the plane surface, the drill is pushed back counter to the transverse direction, so that a stage is formed by the plane surface when drilling the drill hole.

7. The method according to claim 1,
wherein the drill hole is a pilot drill hole and is subsequently further formed by means of a separate deep hole drill as a deep drill hole.

8. A drill which extends along a longitudinal axis and comprises:
a drill tip with a nose angle that is less than 180° for drilling a drill hole,
a lateral surface, on which at least one side blade is formed,
wherein the side blade is designed for milling by means of a feeding in a transverse direction to the longitudinal axis.

9. The drill according to claim 8,
wherein the side blade is designed for milling with a clearance angle of at least 5° and no more than 50°.

10. The drill according to claim 8,
wherein the nose angle is no more than 170°.

11. The drill according to claim 8,
wherein the entire side blade is designed for milling.

12. The drill according to claim 8,
wherein the side blade is designed only on a front-facing milling section for milling.

13. The drill according to claim 8,
wherein the side blade is formed to be two-stage, in that a rear drilling section adjoins the front-facing milling section,
wherein the milling section has a milling diameter that is less than a drilling diameter of the drilling section.

14. The drill according to claim 8,
wherein it is designed as a pilot drill for the creation of a pilot drilling.
